(19) United States
(12) Patent Application Publication
(10) Pub. No.: US 2006/0126882 A1
(43) Pub. Date: Jun. 15, 2006

(54) Earphone

(75) Inventors: Ten-Long Deng, ZhuDng Township (TW); Yu-Hsien Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTek Computer Inc.

(21) Appl. No.: 11/252,896

(22) Filed: Oct. 18, 2005

(30) Foreign Application Priority Data
Dec. 10, 2004 (TW) 93138349

(51) Int. Cl. H04R 25/00

(52) U.S. Cl. 381/381

(57) ABSTRACT

Earphones are provided. An earphone includes a first speaker, a second speaker, and an extendable winding structure. The first speaker can hang on one ear of a person. The second speaker is detachably fixed on the first speaker. The extendable winding structure is disposed in the first speaker and connected with the second speaker. The second speaker can be moved to the other ear of the person by extending the extendable winding structure.

### BACKGROUND

The invention relates to earphones.

Earphones are commonly used sound transmitting electronic devices. Earphones have advantages of compact size and high portability over conventional stereo speakers. Thus, users can listen to their favorite music everywhere at anytime.

Generally, earphones are categorized into two types according to user requirements: the single-eared type and the double-eared type. Single-eared type earphones are appropriate for electronic devices providing mono sound, such as cellular phones. Double-eared type earphones are appropriate for electronic devices providing stereo sound, such as stereo FM radios.

Users need to carry two types of earphones for different situations, which is burdensome. Moreover, users must switch between two types of earphones to suit different electronic devices, which is very inconvenient.

### SUMMARY

Earphones are provided. An exemplary embodiment of an earphone comprises a first speaker, a second speaker, and an extendable winding structure. The first speaker can hang on one ear of a person. The second speaker is detachably fixed on the first speaker. The extendable winding structure is disposed in the first speaker and connected with the second speaker. The second speaker can be moved to the other ear of the person by extending the extendable winding structure.

### DESCRIPTION OF THE DRAWINGS

Earphones can be more fully understood by reading the subsequent detailed description and examples with references made to the accompanying drawings, wherein:

FIG. 1a is an exploded view of an embodiment of an earphone;

FIG. 1b is a front view of an embodiment of an earphone after combination;

FIG. 1c is a back view of an embodiment of an earphone after combination;

FIG. 2a is a schematic view of an embodiment of an earphone functioning as a single-eared earphone;

FIG. 2b is a schematic view of an embodiment of an earphone functioning as a double-eared earphone; and

FIG. 3 is an exploded view of an embodiment of an earphone utilizing another kind of extendable winding structure.

### DETAILED DESCRIPTION

Earphones will be described in greater detail in the following.

A principle aim of the invention is to fix a second speaker on a first speaker of an earphone and gather unnecessary cords in a winding structure. Thus, the earphone can switch between single-eared type and double-eared type for different situations.

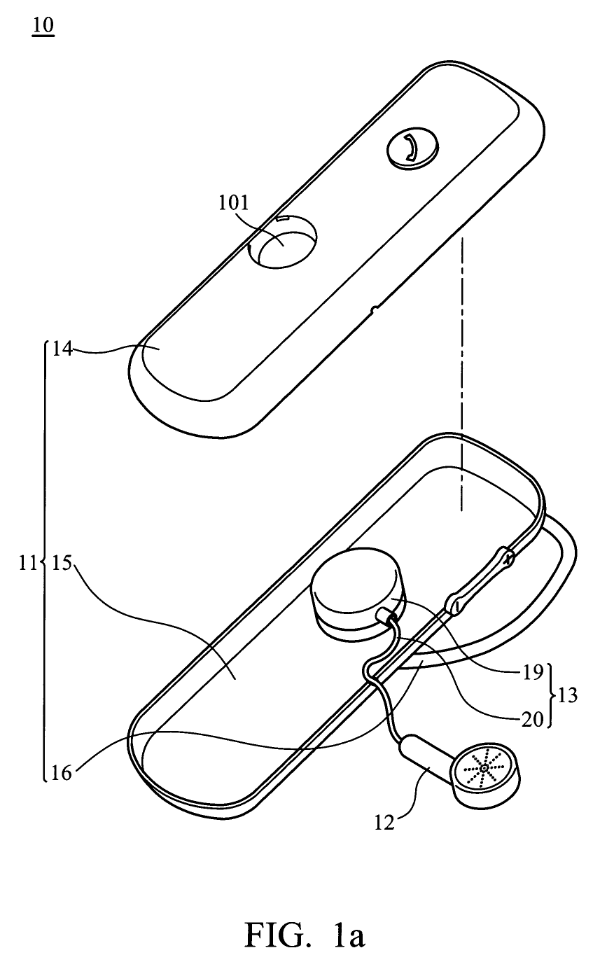

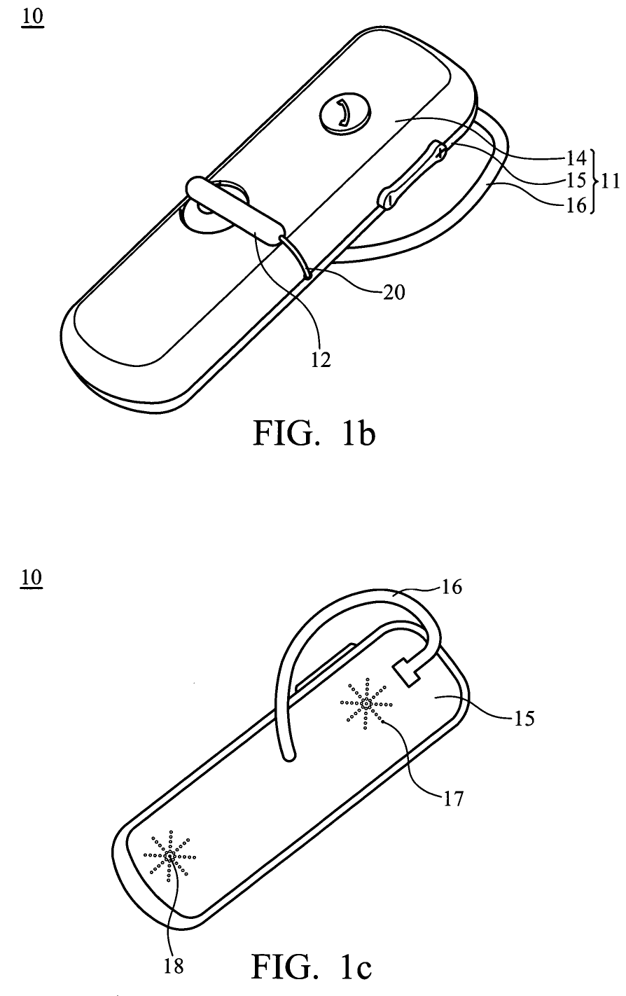

FIG. 1a is an exploded view of an embodiment of an earphone 10. FIG. 1b is a front view of an embodiment of the earphone 10 after combination. FIG. 1c is a back view of an embodiment of the earphone 10 after combination. As shown in the drawings, the earphone 10 is a wireless bluetooth earphone, comprising a first speaker 11, a second speaker 12, an extendable winding structure 13, and a microphone 18, wherein the extendable winding structure 13 and the microphone 18 are disposed in the first speaker 11. It is to be noted that other components, such as a bluetooth transceiver, in the real wireless bluetooth earphone are omitted for simplicity.

The first speaker 11 comprises an upper cover 14, an under cover 15, an ear hanger 16, and other sound components which are omitted for simplicity. The first speaker 11 can hang on one ear of a user by the ear hanger 16. The ear hanger 16 is detachable, allowing the user to replace it with another ear hanger having different shapes or styles to suit his ear. It is to be noted that the first speaker 11 transmits sound via a plurality of holes 17 in the under cover 15 and receives sound via the microphone 18, as shown in FIG. 1c.

The second speaker 12 is an earplug speaker engaged with a circular cavity 101 of the upper cover 14. The second speaker 12 can be freely detached from the upper cover 14 of the first speaker 11.

The extendable winding structure 13 comprises a winding box 19 and an extendable cord 20. The winding box 19 is fixed on the under cover 15 in the first speaker 11. The extendable cord 20 is wound in the winding box 19 and connected with the second speaker 12.

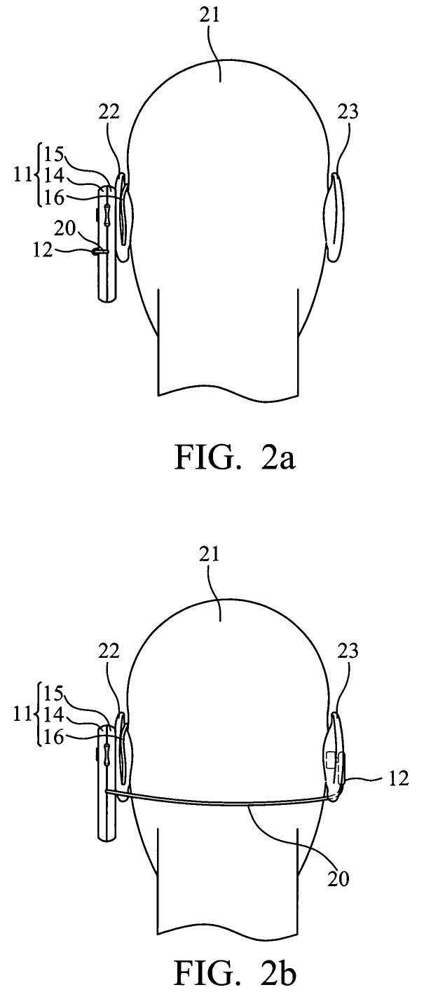

FIG. 2a is a schematic view of an embodiment of the earphone 10 functioning as a single-eared earphone. FIG. 2b is a schematic view of an embodiment of the earphone 10 functioning as a double-eared earphone.

As shown in FIG. 2a, the first speaker 11 hangs on the left ear 22 of the user 21 by the ear hanger 16. When the user 21 needs only mono sound, for example, using a cellular phone via bluetooth connection, the extendable cord 20 remains in the winding box 19, and the second speaker 12 remains on the first speaker 11. The user 21 uses the first speaker 11 and the microphone (not shown in FIG. 2a) to transmit and receive mono sound. The earphone 10 is used as a single-eared type earphone.

As shown in FIG. 2b, in other cases, when the user 21 needs stereo sound, for example, listening to a stereo FM radio, the extendable cord 20 is pulled out from the winding box 19, and the second speaker 12 is thus moved to the right ear 23 of the user 21. The user 21 uses the first speaker 11 and the second speaker 12 to play sound. The earphone 10 is used as a double-eared type earphone.

Therefore, the earphone 10 can switch between single-eared type and double-eared type for different situations. When the user 21 needs only mono sound, the second speaker 12 of the earphone 10 remains fixed on the first speaker 11, and unnecessary cords of the earphone 10 are gathered by the extendable winding structure 13, thereby the earphone 10 is used as a single-eared type earphone. When the user 21 needs stereo sound, the second speaker 12 is detached from the first speaker 11 and moved to the other ear of the user 21 by extending the extendable winding structure 13, thereby the earphone 10 is used as a double-eared type earphone.

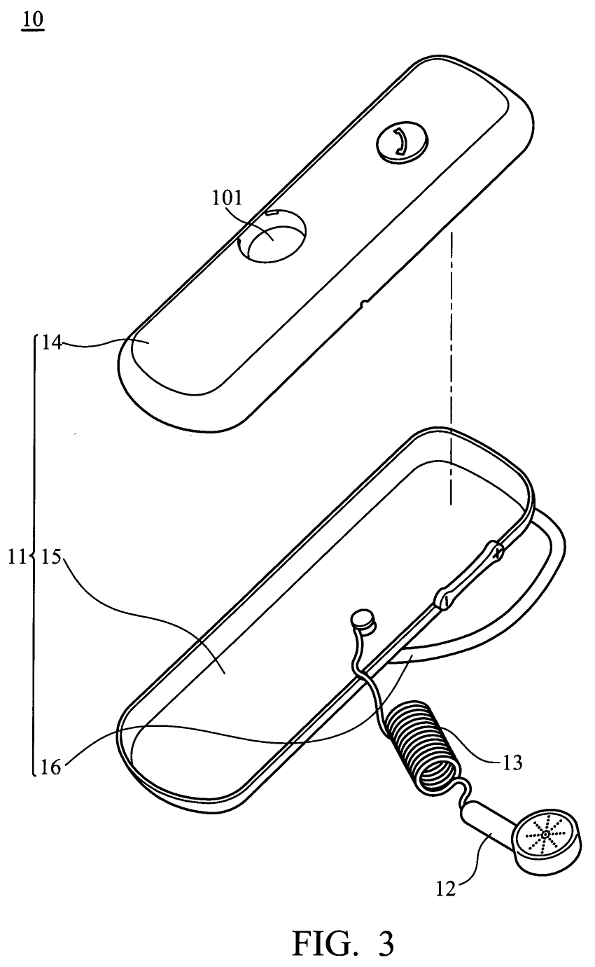

Moreover, in some embodiments of the earphone 10, the extendable winding structure 13 can be designed in other styles or structures. For example, FIG. 3 is an exploded view of an embodiment of the earphone 10 utilizing another kind of extendable winding structure 13. As shown in FIG. 3, the extendable winding structure 13 is a spring cable.

In some embodiments of an earphone, a second speaker can be fixed on a first speaker, and unnecessary cords of the earphone can be gathered by a winding structure, thereby the earphone is used as a single-eared type earphone having advantages of compact size and high portability. Moreover, when necessary, the second speaker can be moved to the other ear of the user by extending the winding structure, thereby the earphone is used as a double-eared type earphone having advantages of high flexibility in use.

While the invention has been described by way of example and in terms of several embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An earphone, comprising:
a first speaker for hanging on one ear of a person;
a second speaker detachably fixed on the first speaker; and
an extendable winding structure disposed in the first speaker and connected with the second speaker;
wherein the second speaker can be moved to the other ear of the person by extending the extendable winding structure.

2. The earphone as claimed in claim 1, wherein the first speaker comprises an ear hanger, and the first speaker hangs on one ear of the person by the ear hanger.

3. The earphone as claimed in claim 2, wherein the ear hanger is detachable.

4. The earphone as claimed in claim 1, wherein the extendable winding structure comprises a winding box and an extendable cord, the winding box is fixedly disposed in the first speaker, the extendable cord is connected with the second speaker, and the extendable cord is wound in the winding box.

5. The earphone as claimed in claim 1, wherein the extendable winding structure is a spring cable.

6. The earphone as claimed in claim 1, wherein the second speaker is an earplug speaker.

7. The earphone as claimed in claim 1 further comprising a microphone disposed in the first speaker for receiving sound.
